(19) United States
(12) Patent Application Publication
(10) Pub. No.: US 2026/0021513 A1
(43) Pub. Date: Jan. 22, 2026

(54) BLADE UNIT AND CLEANING APPARATUS FOR REMOVING SLAG SIMULTANEOUSLY FROM OPPOSITE SIDES OF A SLAT

(71) Applicant: TRUMPF SCHWEIZ AG, Gruesch (CH)

(72) Inventors: Matthias Accola, Fanas (CH); Andreas Neuweiler, Chur (CH)

(21) Appl. No.: 19/340,929

(22) Filed: Sep. 26, 2025

Related U.S. Application Data
(63) Continuation of application No. PCT/EP2024/057479, filed on Mar. 20, 2024.

(30) Foreign Application Priority Data
Mar. 31, 2023 (DE) 10 2023 108 270.1

(51) Int. Cl. B08B 1/30; B08B 1/16; B23K 10/00; B23K 26/70

(52) U.S. Cl. CPC B08B 1/30; B08B 1/165; B23K 10/003; B23K 26/702

(57) ABSTRACT

A blade unit, including a substantially hollow-cylindrical shape with an at least partially non-rotationally symmetrical inner contour, for rotationally secured mounting on a cooperating tool shaft of a cleaning apparatus. The blade unit further includes at least one first scraping blade which extends parallel to a longitudinal extent of the blade unit and has a straight cutting edge. The blade unit further includes at least one second scraping blade which extends parallel to the longitudinal extent of the blade unit and has a serrated cutting edge, the at least one first and second scraping blades being distributed uniformly in a circumferential direction.

### CROSS REFERENCE TO RELATED APPLICATIONS

This application is a continuation of International Application No. PCT/EP2024/057479 (WO 2024/200167 A1), filed on Mar. 20, 2024, and claims benefit to German Patent Application No. DE 10 2023 108 270.1, filed on Mar. 31, 2023. The aforementioned applications are hereby incorporated by reference herein.

### FIELD

The invention relates to a blade unit for rotationally secured mounting on a cooperating tool shaft of a cleaning apparatus, and to a cleaning apparatus for removing slag simultaneously from opposite sides of a slat.

### BACKGROUND

When workpieces are machined on a machine tool, they are often stored on a workpiece support. Particularly when thermally cutting workpieces, workpiece supports are used which have a multitude of slats arranged in parallel. On their upper sides, the slats define a contact surface for the workpiece to be machined, e.g., a sheet metal. The slats are usually jagged on their upper side so that the workpieces can rest on the tips of the spikes of the slats.

During the machining process, the slats become heavily contaminated, especially between the support spikes and on their longitudinal sides in the region of the support spikes. For example, when laser cutting sheet metal, molten metal and slag drip from above onto the slats and adhere there in part. From time to time, the slats must be cleaned of any stubborn deposits.

From DE 20 2004 015 922 U1, a slat cleaner is known which moves in a motor-driven manner along a slat to be cleaned. Cleaning rollers are provided as cleaning device carriers, which rotate on the opposite longitudinal side surfaces of the respective slat and thereby apply cleaning devices in the form of cleaning bars to the respective longitudinal side surface of the slat. The rotational axes of the cleaning rollers and also the cleaning bars run perpendicular to the longitudinal axis of the slat and thus parallel to its longitudinal sides.

EP 3 218 122 B1 discloses a cleaning tool for removing unwanted slag that has accumulated on opposite sides of the slat of a work table. The cleaning tool has a pair of driven tool shafts, each containing a scraping tool. The scraping tools are positioned on opposite sides of the slat to clean both sides of the slat. A single motor rotates both scraping tools. A pre-tensioning element keeps the two scraping tools in close proximity to the slat.

### SUMMARY

In an embodiment, the present disclosure provides a blade unit, comprising a substantially hollow-cylindrical shape with an at least partially non-rotationally symmetrical inner contour, for rotationally secured mounting on a cooperating tool shaft of a cleaning apparatus. The blade unit further comprises at least one first scraping blade which extends parallel to a longitudinal extent of the blade unit and has a straight cutting edge. The blade unit further comprises at least one second scraping blade which extends parallel to the longitudinal extent of the blade unit and has a serrated cutting edge, the at least one first and second scraping blades being distributed uniformly in a circumferential direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a blade unit according to an embodiment of the present disclosure;

FIG. 2 shows another view of the blade unit from FIG. 1 from a 90° rotated angle;

FIG. 3 shows another view of the slightly pivoted blade unit from FIG. 2;

FIG. 4 shows a schematic view of a front end of the blade unit from FIG. 2;

FIG. 5 shows a schematic representation of an arrangement with a plurality of slats;

FIG. 6 shows a perspective view obliquely from above of a cleaning apparatus according to an embodiment of the present disclosure;

FIG. 7 shows a perspective view obliquely from below of the cleaning apparatus with two blade units from FIG. 6;

FIG. 8 shows a partially enlarged view of the cleaning apparatus from FIG. 7 in the area of the two blade units;

FIG. 9 shows a partial view of the cleaning apparatus in the area of the blade units from a view parallel to a rotational axis of the blade units; and

FIG. 10 shows a side view of the cleaning apparatus from FIG. 6.

### DETAILED DESCRIPTION

In an embodiment, the present disclosure provides an improved blade unit and a cleaning apparatus of the type mentioned above, in particular with an improved cleaning effect of the blade unit and the cleaning apparatus. Furthermore, an embodiment of the present disclosure enables cleaning of comparatively hard slag deposits.

The foregoing advantages are achieved according to an embodiment of the present disclosure by a blade unit having:
a substantially hollow-cylindrical shape with a non-rotationally symmetrical inner contour, for rotationally secured mounting on a cooperating tool shaft of a cleaning apparatus, at least one scraping blade which extends parallel to the longitudinal extent of the blade unit and has a straight cutting edge,
at least one scraping blade which extends parallel to the longitudinal extent of the blade unit and has a serrated cutting edge, the at least two scraping blades being distributed uniformly in the circumferential direction.

By providing at least one scraping blade which extends parallel to the longitudinal extent of the blade unit and has a serrated cutting edge, the slag is broken up or torn up on contact with this special cutting geometry, allowing even relatively hard slag to be removed from the slats. So-called “hard slag” can arise depending on various machining and process parameters. For example, depending on material, thickness, process temperature, cutting type, and the like.

The scraping blade with the serrated cutting edge can be a scraping blade with a jagged cutting edge. The serrated or jagged cutting edge can have a sequence of uniform serrations or spikes. The serrated or jagged cutting edge can have serrations or spikes of different shapes. The serrated or jagged cutting edge can have an alternating sequence of serrations or spikes of different shapes.

If there is an even number of scraping blades, two adjacent scraping blades can always have different cutting edges. If there is an even number of scraping blades, the different cutting edges in the circumferential direction preferably have an alternating sequence. If there is an odd number of scraping blades, a maximum of one pair of adjacent scraping blades can have the same cutting edge. Except for this one pair of adjacent scraping blades, if there is an odd number of scraping blades, the remaining scraping blades have with different cutting edges in the circumferential direction in an alternating sequence.

At least one of the scraping blades with a straight cutting edge can have at least one groove. At least one of the scraping blades with a straight cutting edge can have at least two grooves, which are each arranged in an outer third of the blade unit in the longitudinal direction. The groove serves as a wear indicator for the user of the blade unit and shows when a blade unit is used up or needs to be replaced. If wear is uneven after an initial period of use, the blade units can also be disassembled and reassembled in the opposite orientation on the other tool shaft, which can achieve more even wear.

The inner contour can have a polygonal cross-section at least in sections. The inner contour can have at least a triangular cross-section at least in sections. The inner contour can have a square cross-section at least in sections. The shape of the inner contour enables a rotation-proof mounting on a cooperating tool shaft of a cleaning apparatus. The inner contour can have, at least in sections, a cross-section with four pairs of parallel side edges and connecting areas that are widened outwards.

Advantages of the present disclosure are achieved by an embodiment including a cleaning apparatus for removing slag simultaneously from opposite sides of a slat, in particular a slat of a laser cutter or plasma cutter, comprising:
a bearing plate with an opening,
a drive arranged on an upper side of the bearing plate, in particular a preferably electric gear motor,
two tool shafts, which can be driven in opposite directions of rotation, the tool shafts each having their first end coupled to the drive, and a respective free end portion, which is located opposite the first end, projecting through the opening in the bearing plate, wherein a blade unit as described above is mounted on each of the tool shafts.

The advantages of the cleaning apparatus are also based on the advantages of the blade unit described above.

The tool shafts can rotate with the blade units in opposite directions of rotation in order to achieve an upwardly inclined cleaning effect on opposite sides of a slat to be cleaned. The tool shafts can be detachable.

The two blade units are preferably mounted in such a way that uniform scraping blades always interact with each other in the respective direction of rotation of the blade units. In other words, the scraping blades of the two blade units that act simultaneously on the slat in the direction of rotation preferably have the same blade shape with the same cutting edge. It is also conceivable that the two blade units are mounted in such a way that different scraping blades always interact with each other in the respective direction of rotation of the blade units.

The outer contour of the tool shaft can have a polygonal cross-section at least in sections. The outer contour of the tool shaft can have a triangular cross-section at least in sections. The outer contour of the tool shaft can have a square cross-section at least in sections. The outer contour of the tool shaft is preferably matched to the inner contour of the blade unit.

The tool shafts can each have a holding mechanism at their free end, which releasably fixes the respective blade unit on the respective tool shaft. The holding mechanism can have a spring-loaded bayonet closure. The spring-loaded bayonet closure can be operated by means of a push button.

The tool shafts can be spring-loaded towards each other, in particular in the radial direction. The tool shafts can be spring-loaded towards each other by means of a pre-tensioning element.

The tool shafts with the blade units can protrude at an angle of 20-25° to a plane of a bearing plate from an opening in the bearing plate.

Advantageous embodiments can be used individually or in combination with one another.

Embodiments of the present disclosure are explained in more detail below with reference to an advantageous exemplary embodiment shown in the figures. However, the present disclosure is not limited to this embodiment.

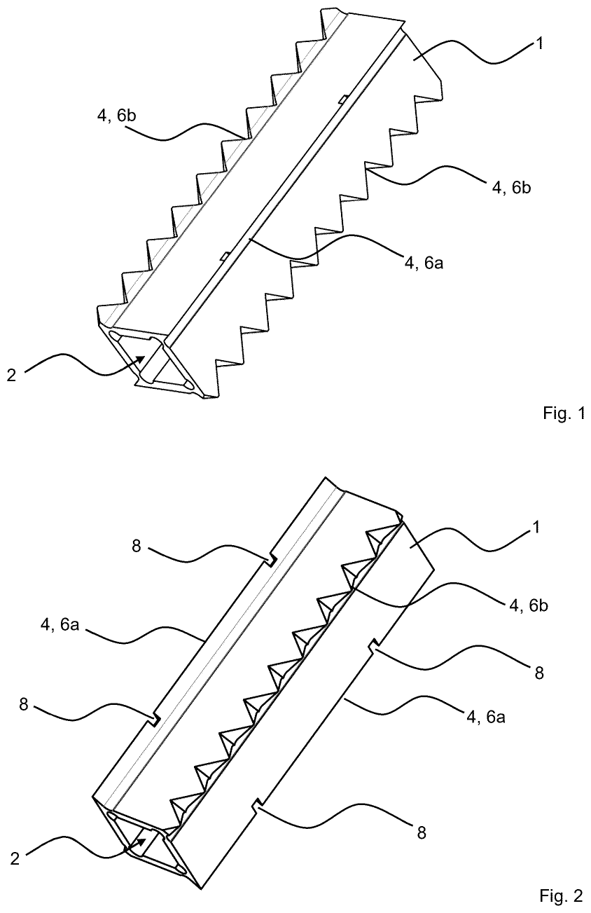

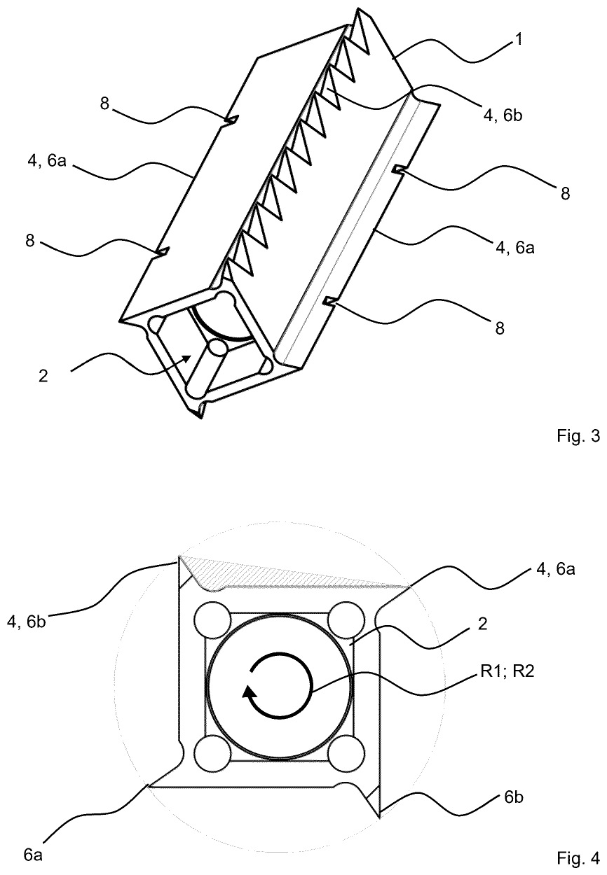

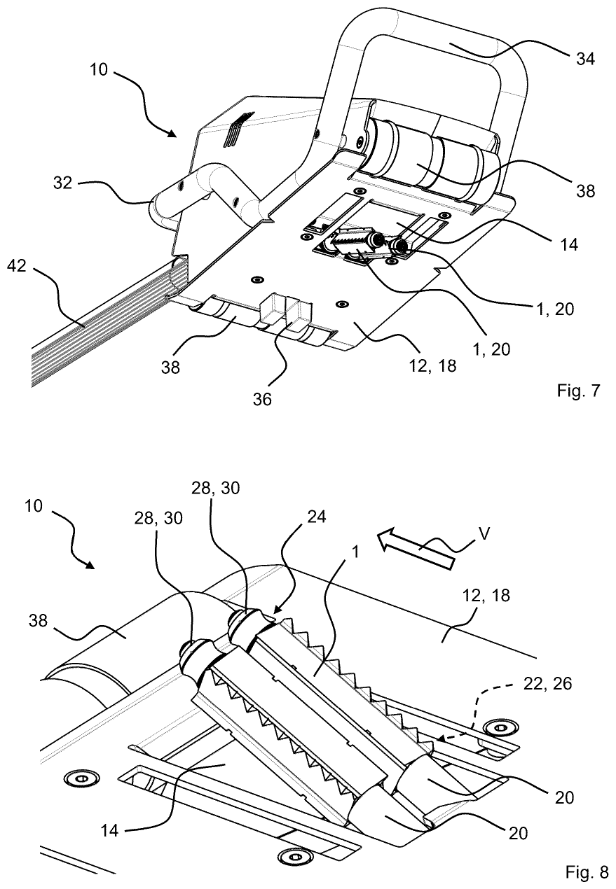

FIGS. 1 to 4 show views of a blade unit 1 according to the present disclosure from different angles and are described together below. The blade unit 1 has a substantially hollow-cylindrical shape with an at least partially non-rotationally symmetrical inner contour 2. The at least partially non-rotationally symmetrical inner contour 2 serves as an attachment for rotationally secured mounting on a cooperating tool shaft 20 of a cleaning apparatus 10, as described, for example, below with reference to FIGS. 6 to 10. The inner contour 2 has, at least in sections, a substantially polygonal cross-section. In this case, a cross-section with four pairs of parallel side edges and connecting areas that are widened outwards. Preferably, the blade unit 1 has an inner contour 2 with such a polygonal cross-section at its two end portions opposite each other in the longitudinal direction.

The blade unit 1 has at least one scraping blade 4 which extends parallel to the longitudinal extent of the blade unit 1 and has a straight cutting edge 6a. Furthermore, the blade unit 1 has at least one scraping blade 4 which extends parallel to the longitudinal extent of the blade unit 1 and has a serrated cutting edge 6b, the at least two scraping blades 4 being distributed uniformly in the circumferential direction. The scraping blades 4 have a shape or protrude in an orientation adapted to the direction of rotation R1, R2 of the blade unit 1.

In embodiments of the blade unit 1 with an even number of scraping blades 4, two adjacent scraping blades 4 always have different cutting edges 6a, 6b. In embodiments of the blade unit 1 with an odd number of scraping blades 4, a maximum of one pair of adjacent scraping blades 4 has the same cutting edge 6a, 6b.

At least one of the scraping blades 4 with a straight cutting edge 6a has at least one groove 8. In the present case, each of the scraping blades 4 with a straight cutting edge 6a has two grooves 8, which are each arranged in an outer third of the blade unit 1 in the longitudinal direction. The grooves 8 preferably serve as a wear indicator and show when the corresponding blade unit should be rotated or replaced.

As seen in the front view of the blade unit 1 in FIG. 4, an embodiment of the blade unit 1 illustrates an intermediate space, shown in dashed lines, between two adjacent scraping blades 4, which has been isolated for clarity. This ensures that the rotating blade unit 1 is not permanently engaged, thereby allowing easier feed of the cleaning apparatus 10. The size of the defined gap is preferably matched to a rotational speed of the blade units 1 and specifies the period of time in which a force-free or force-reduced feed is possible.

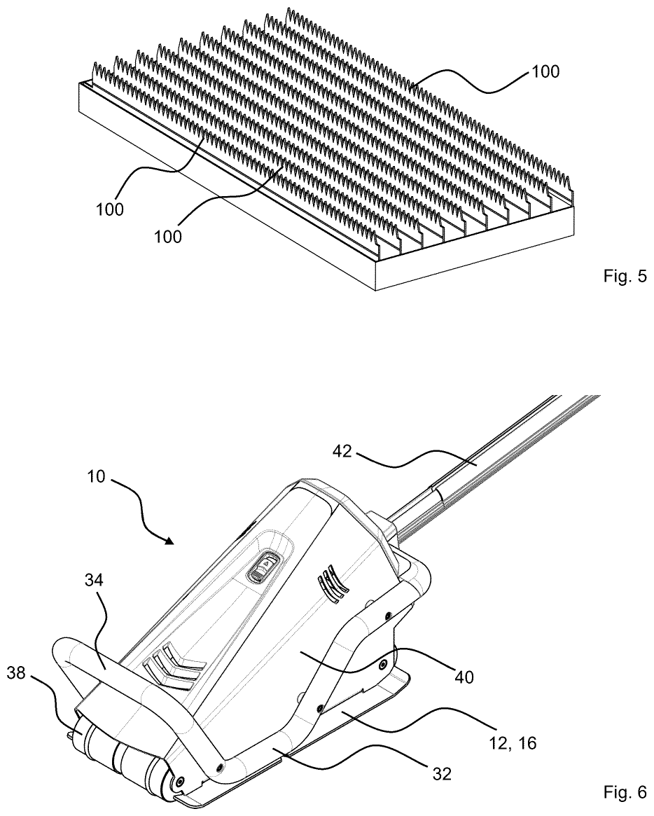

FIG. 5 shows a schematic representation of an arrangement with a plurality of slats 100. The present disclosure relates to slats 100 as provided in a laser cutter. This could also be, for example, a plasma cutter.

FIGS. 6 to 8 show a cleaning apparatus 10 according to the present disclosure from different perspectives and are described together below. The cleaning apparatus 10 for removing slag simultaneously from opposite sides of a slat 100, in particular a slat 100 of a laser cutter or plasma cutter, has a bearing plate 12. The bearing plate 12 has an opening 14. The bearing plate 12 is used to move over the slat 100. Preferably, the bearing plate 12 extends in width over a plurality of slats 100 arranged next to one another. This prevents the cleaning apparatus 10 from tipping over on the slats 100.

The cleaning apparatus 10 has a drive arranged on an upper side 16 of the bearing plate 12. Furthermore, two tool shafts 20, which can be driven in opposite directions of rotation R1, R2, are provided, the tool shafts 20 each having their first end coupled to the drive, and a respective free end portion 22, which is located opposite the first end, projecting through the opening 14 in the bearing plate 12. In the region of the free end portion 22, the tool shafts 20 have, at least in sections, an outer contour 26 that is drivingly coupled to the inner contour 2 of the blade units 1.

The cleaning apparatus 10 has a housing 40. The housing 40 is arranged on an upper side 16 of the bearing plate 12. A bracket 32 is attached around the housing 40 and fulfills a plurality of functions. On the one hand, the bracket 32 gives the housing 40 more stability and serves as a protective bracket. The bracket 32 has a handle portion 34 that is partially spaced apart from the housing 40. An operator can grasp the cleaning apparatus 10 at the handle portion 34 and, for example, lift it off the slat 100 and/or place it on the next slat 100 to be cleaned. The handle portion 34 can also serve as a stand when the cleaning apparatus 10 is placed upright when not in use.

A guide aid 36 is provided on the lower side 18 of the bearing plate 12, at a rear end portion of the bearing plate 12 in the feed direction V, which guide aid 36 prevents tilting or lateral twisting of the cleaning apparatus 10 on the slat 100. A roller 38 is arranged in front of and behind the bearing plate 12 in the feed direction V, which serves to facilitate rolling over the slat 100. In addition, the preceding roller 38 can also serve to roll on a floor during transport of the cleaning apparatus 10.

A blade unit 1 is mounted on each of the tool shafts 20, as shown in detail in FIG. 8. The tool shafts 20 together with the blade units 1 protrude from an opening 14 in the bearing plate 12 at an angle of 20-25° relative to the plane of the bearing plate 12.

The tool shafts 20 each have a holding mechanism 28 at their free end 24, which releasably fixes the respective blade unit 1 on the respective tool shaft 20. The holding mechanism 28 comprises a spring-loaded bayonet closure. The bayonet closure can be operated by means of a push button 30.

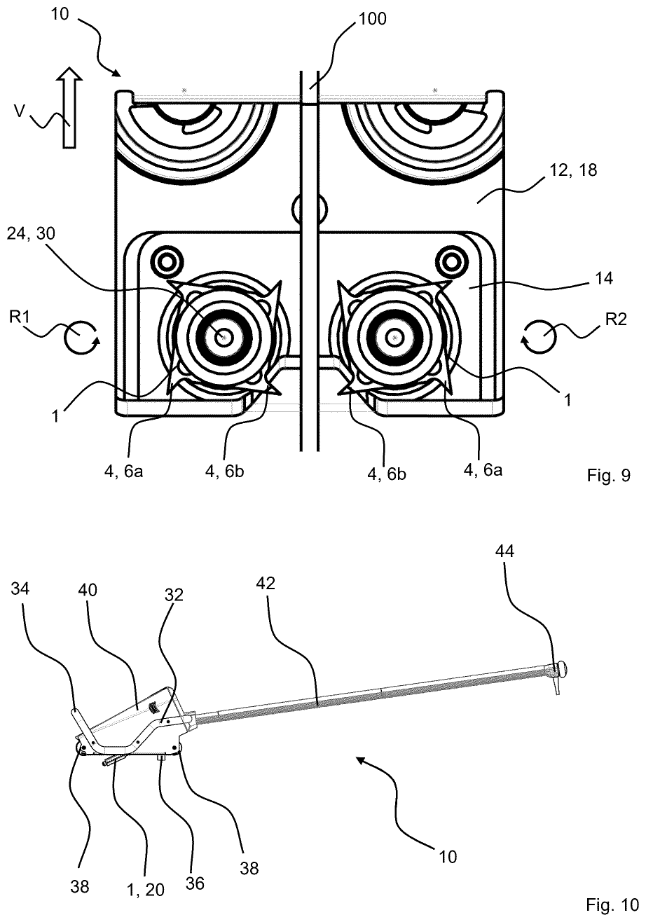

FIG. 9 shows a partial view of the cleaning apparatus 10 in the area of the blade units 1 from a view parallel to the rotational axes R1, R2 of the blade units 1.

The tool shafts 20 rotate with the blade units 1 in opposite directions of rotation R1, R2 in order to achieve an upwardly inclined cleaning effect on opposite sides of a slat 100 to be cleaned. Two blade units 1 are mounted in such a way that uniform scraping blades 4 always interact with each other in the respective direction of rotation R1, R2 of the blade units 1.

FIG. 10 shows a side view of the cleaning apparatus 10. The cleaning apparatus 10 has a stem 42, at the free end of which an operating handle 44 is arranged. A user can use the operating handle 44 to adjust settings, such as a rotational speed of the tool shafts 20, of the cleaning apparatus 10.

The features disclosed in the above description and the drawings can be important both individually and in combination for the realization of the present disclosure in its various embodiments.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements. e.g., . A, any subset from the listed elements, e.g., A and B. or the entire list of elements A. B and C.

### LIST OF REFERENCE SIGNS

1 Blade unit
2 Inner contour
4 Scraping blade
6a Straight cutting edge
6b Serrated cutting edge
8 Groove
10 Cleaning apparatus
12 Bearing plate
14 Opening
16 Upper side
18 Lower side
20 Tool shaft
22 Free end portion
24 Front end
26 Outer contour
28 Holding mechanism
30 Push button
32 Bracket
34 Handle portion
36 Guide aid
38 Roller
40 Housing
42 Stem
44 Operating handle
100 Slat
R1 Direction of rotation
R2 Direction of rotation
V Feed direction

1. A blade unit, comprising:
a substantially hollow-cylindrical shape with an at least partially non-rotationally symmetrical inner contour, for rotationally secured mounting on a cooperating tool shaft of a cleaning apparatus;
at least one first scraping blade which extends parallel to a longitudinal extent of the blade unit and has a straight cutting edge; and
at least one second scraping blade which extends parallel to the longitudinal extent of the blade unit and has a serrated cutting edge, the at least one first and second scraping blades being distributed uniformly in a circumferential direction.

2. The blade unit according to claim 1, wherein, with an even number of scraping blades, two adjacent scraping blades always have different cutting edges, and, with an odd number of scraping blades, a maximum of one pair of adjacent scraping blades has the same cutting edge.

3. The blade unit according to claim 1, wherein at least one of the first and second scraping blades with a straight cutting edge has at least one groove.

4. The blade unit according to claim 1, wherein at least one of the first and second scraping blades with a straight cutting edge has at least two grooves, which are each arranged in an outer third of the blade unit in the longitudinal direction.

5. The blade unit according to claim 1, wherein the inner contour has a polygonal cross-section at least in sections.

6. A cleaning apparatus for removing slag simultaneously from opposite sides of a slat of a laser cutter or plasma cutter, comprising:
a bearing plate with an opening;
a drive arranged on an upper side of the bearing plate,;
two tool shafts, which can be driven in opposite directions of rotation, the tool shafts each having their first end coupled to the drive, and a respective free end portion, which is located opposite the first end, projecting through the opening in the bearing plate; and
the blade unit according to claim 1 mounted on each of the tool shafts.

7. The cleaning apparatus according to claim 6, wherein the tool shafts rotate with the blade units in opposite directions of rotation, in order to achieve an upwardly inclined cleaning effect on opposite sides of a slat to be cleaned.

8. The cleaning apparatus according to claim 6, wherein two blade units are mounted such that uniform scraping blades always interact with each other in the respective direction of rotation of the blade units.

9. The cleaning apparatus according to claim 6, wherein an outer contour of the tool shaft has a polygonal cross-section at least in sections.

10. The cleaning apparatus according to claim 6, wherein the tool shafts each have a holding mechanism at their free end face, which releasably fixes the respective blade unit on the respective tool shaft.

11. The cleaning apparatus according to claim 10, wherein the holding mechanism comprises a spring-loaded bayonet closure, and the bayonet closure can be actuated by a push button.

12. The cleaning apparatus according to claim 6, wherein the tool shafts are spring-loaded towards each other.

13. The cleaning apparatus according to claim 6, wherein the tool shafts can be released.

14. The cleaning apparatus according to claim 6, wherein the tool shafts with the blade units protrude at an angle of 20-25° to a plane of the bearing plate from an opening in the bearing plate.
